(19) United States
(12) Patent Application Publication
(10) Pub. No.: US 2019/0323771 A1
(43) Pub. Date: Oct. 24, 2019

(54) DEVICE FOR DRYING RESEALABLE BAGS

(71) Applicants: Margaret Mulvaney, Coggon, IA (US); Mark Mulvaney, Coggon, IA (US)

(72) Inventors: Margaret Mulvaney, Coggon, IA (US); Mark Mulvaney, Coggon, IA (US)

(21) Appl. No.: 16/392,789

(22) Filed: Apr. 24, 2019

Related U.S. Application Data
(60) Provisional application No. 62/661,763, filed on Apr. 24, 2018.

(51) Int. Cl. F26B 11/22; A47L 19/04; B65D 33/14

(52) U.S. Cl. CPC F26B 11/22; B65D 33/14; A47L 19/04

(57) ABSTRACT

The device for drying resealable bags includes a tray having a bottom wall, sidewalls, and end walls that form a chamber. Pivotally connected to the tray are a plurality of support members. The support members include a pair of side posts connected by a cross bar and preferably are different heights and widths.

### CROSS REFERENCE TO RELATED APPLICATION

This application claims the benefit of the priority of U.S. Provisional Application No. 62/661,763 filed on Apr. 24, 2018, the contents of these applications are hereby incorporated by reference in their entirety.

### BACKGROUND OF THE INVENTION

This invention is directed to a device for drying resealable bags, and more particularly of drying resealable bags of varying sizes. This is for the intention of promoting recycling of resealable bags and reducing waste.

Resealable bags are known in the art and used for both economic and environmental reasons. Sometimes there is a desire to reuse the bag which requires sanitizing the bag by washing and drying the bag.

Devices for drying bags are known in the art, but limited in their usefulness. First, these devices are not designed to be dishwasher safe for cleaning periodically. Second, these devices are limited for use with a particular size of bag. Therefore, a need exists in the art for a device that addresses these needs. This device will be designed to be cleaned (without bags attached) in the dishwasher, and be suitable for drying multiple bag sizes.

An objective of the present invention is to provide a device for drying resealable bags that is dishwasher safe.

Another objective of the present invention is to provide a device for drying resealable bags that is used with bags of different sizes.

These and other objectives will be apparent to those skilled in the art based upon the following written description, drawings and claims.

### SUMMARY OF THE INVENTION

A device for drying resealable bags includes a tray having a bottom wall, side walls and end walls. Pivotally connected to the tray are a plurality of support members having a pair of side posts connected by a cross bar. The support members have a size and shape to accommodate different sizes of bags. Preferably, the support members each have a different height and width and are adapted and positioned to nest within the tray in a lowered position.

### BRIEF DESCRIPTION OF THE DRAWINGS

FIG. 1 is a top perspective view of a bag drying device;

FIG. 2 is a perspective view of a bag drying device;

FIG. 3 is an end view of a bag drying device;

FIG. 4 is a side view of a bag drying device; and

FIG. 5 is a perspective view of a bag drying device.

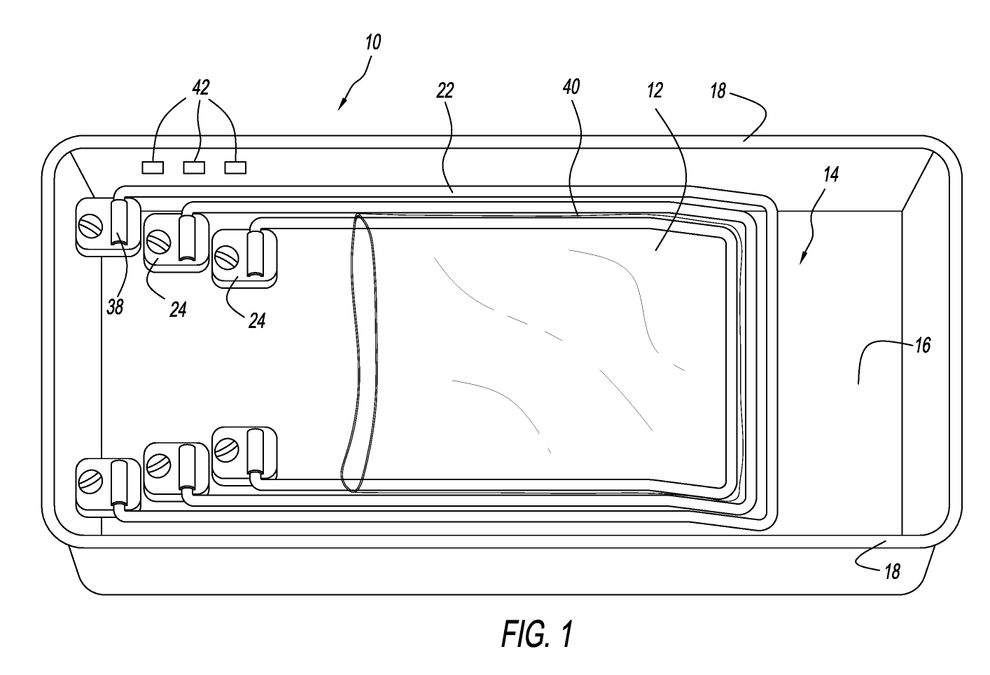

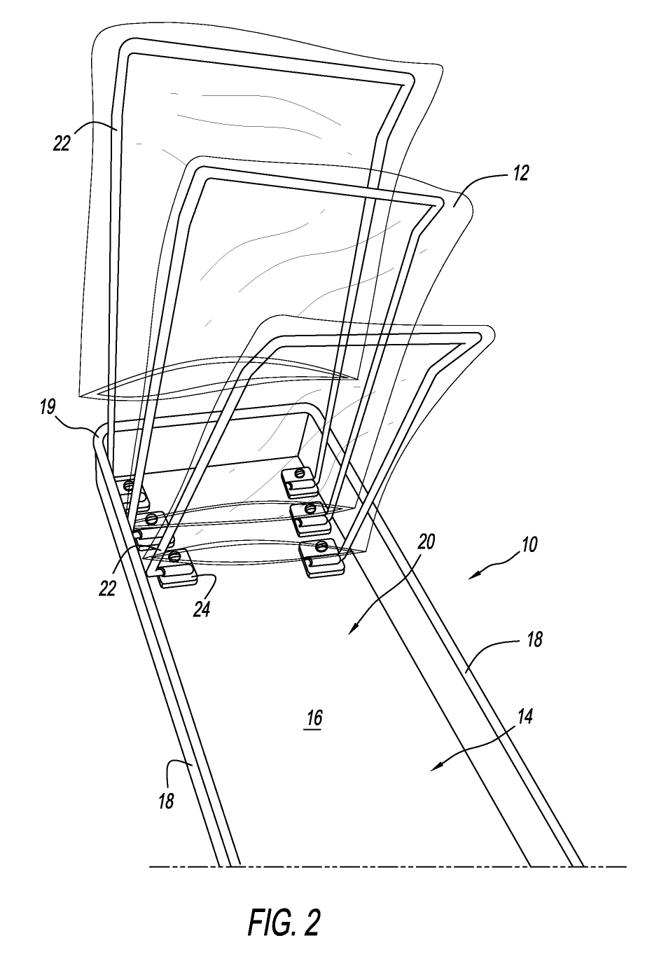

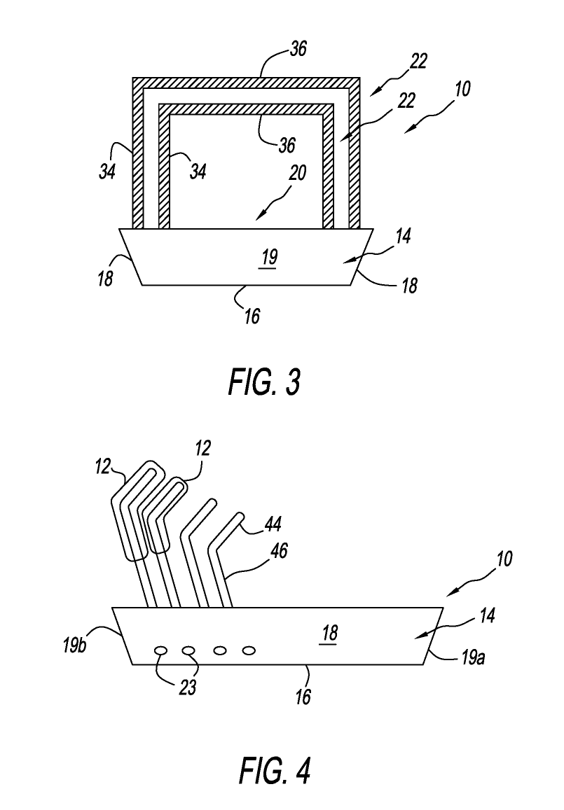

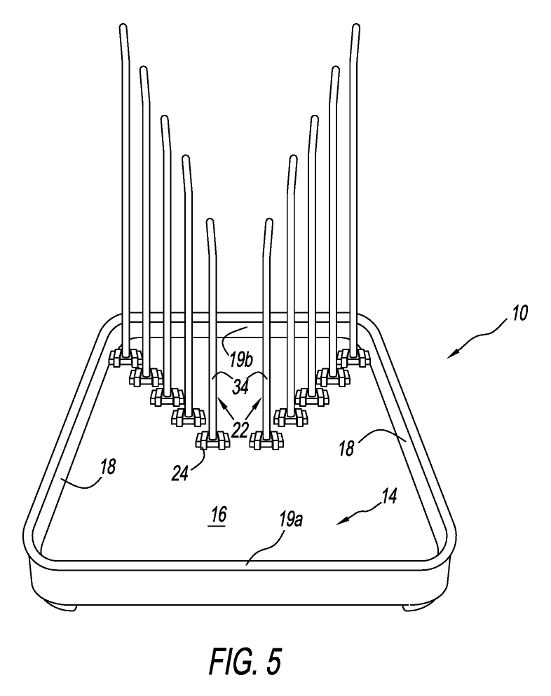

### DETAILED DESCRIPTION

Referring to the Figures, a device 10 for drying resealable bags 12 includes a tray 14. The tray 14 is of any size, shape and structure and in the example shown has a bottom wall 16 and sidewalls 18 and end walls 19 that extend generally upwardly from an outer perimeter of the bottom wall 16 to form a chamber 20 with an open top.

Pivotally connected to the tray 14 is a plurality of support members 22. The support members are pivotally connected through holes 23 in the sidewalls 18 or to brackets 24 connected to the bottom wall 16.

The support members 22 are of any size, shape, and structure. In one example, the support members 22 have a pair of side posts 34 separated by a cross bar 36. In an alternative example, the support members 22 include just a pair of spaced side posts 34. Each end of the side posts 34 have a foot 38 that extends away from the side post 34 and toward the sidewall 18 of the tray 14. The feet 38 are configured to be rotatably received within holes 23 or brackets 24. The support members 22 are preferably of different heights and widths to not only accommodate bags 12 of different sizes, but also to permit nesting of the support members 22 when in a lowered position. More specifically, as each support member 22 is connected to the tray between a first end 19a and a second end 19b, the support members 22 are progressively taller and wider. In this manner, as the support members 22 are moved from a raised position to a lowered position, a first support member 22 fits within the side posts 34 and the cross bar 36 of an adjacent support member 22.

To maintain the support members 22 in a lowered position a clip or lock 40 is positioned on the tray 14 and adapted to selectively engage the support members 22. To prevent the support members 22 from rotating beyond a desired vertical angle in a raised position, stops 42 on an inner surface of the sidewalls 18 or brackets 24 are positioned and adapted to engage the side posts 34 of the support member 22 when in a raised position. Alternatively, the posts 34 engage a portion of the molding of the tray.

To assist in holding the bag 12 apart and allow air circulation to the interior of the bag 12, the side posts 34 preferably have a bent section 44 that dwells in a plane other than the plane of the straight or vertical section 46.

Alternatively, the cross bar 36 is slidably connected to the side posts 34. In this manner, when the cross bar 36 is slid down the side posts 34 toward the tray 14, because the side posts 34 are made of a resilient material, they can be manually pulled toward one another to fit a bag of any size. This process could also be done with the cross bar 36 fixed to the side posts 34 between the ends of the side posts 34.

From the above discussion and accompanying figures it will be appreciated that the device 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A device for drying resealable bags, comprising:
a tray having a bottom wall, sidewalls, a first end wall, and a second end wall; and
a plurality of support members pivotally connected to the tray.

2. The device of claim 1 wherein the plurality of support members are pivotally connected to the tray through holes in the sidewalls of the tray.

3. The device of claim 1 wherein the plurality of support members are pivotally connected to brackets in the bottom wall of the tray.

4. The device of claim 1 wherein the plurality of support members have a pair of side posts connected by a cross bar.

5. The device of claim 1 wherein the plurality of support members each have a different height and width.

6. The device of claim 1 wherein the plurality of support members are progressively taller and wider as the plurality of support members are positioned in spaced relation from the first end to the second end of the tray.

7. The device of claim 1 wherein the plurality of support members are adapted to nest in a lowered position.

8. The device of claim 7 wherein the tray has a clip adapted to hold the plurality of support members in a lowered position.

9. The device of claim 1 further comprising stops positioned and adapted to prevent the plurality of support members from rotating beyond a predetermined vertical angle when in a raised position.

10. The device of claim 1 wherein the plurality of support members have side posts with a bent section and a straight section.

11. The device of claim 1 wherein the plurality of support members have a cross bar slidably connected to a pair of side posts.
